(19) United States
(12) Patent Application Publication
(10) Pub. No.: US 2008/0175940 A1
(43) Pub. Date: Jul. 24, 2008

(54) DEVICE FOR REWORKING OF THERMOPLASTIC MATERIAL

(75) Inventors: Gerold BARTH, Wilhering (AT); Josef Hochreiter, Freistadt (AT); Gunter Kroiss, Pasching (AT); Thomas Pichler, St. Peter am Wimberg (AT); Walter Schmedler, Wels (AT)

Correspondence Address: YOUNG & THOMPSON, 209 Madison Street, Suite 500, ALEXANDRIA, VA, 22314, US

(73) Assignee: NEXT GENERATION RECYCLINGMASCHINEN GMBH, FELDKIRCHEN (AT)

(21) Appl. No.: 11/927,752

(22) Filed: Oct. 30, 2007

(30) Foreign Application Priority Data
Oct. 30, 2006 (AT) A 1819/2006

(51) Int. Cl. B29C 47/36

(52) U.S. Cl. 425/202

(57) ABSTRACT

A device for reworking thermoplastic material has a milling unit for milling the plastic material and an extruder (5). The milling unit has a cylinder (1) with a supply opening and with a knife shaft and the extruder has an extruder screw (7) in a screw tube (6). The cylinder is connected to the screw tube of the extruder via a connecting opening (4). In order to prevent deposition of plastic material in the connecting opening, the connecting opening with reference to a plane (10) which lies in the axis of rotation (2) of the knife shaft and at a right angle to the axis of rotation (8) of the extruder screw is arranged asymmetrically viewed in the direction of rotation (11) of the knife shaft. In this way the wall thickness on the edge (12) of the connecting opening can be made much narrower; this minimizes this problem.

The invention relates to a device for reworking thermoplastic material with a milling means for milling the plastic material and with an extruder, the milling means having a cylinder with a supply opening and with a knife shaft, the extruder having an extruder screw in a screw tube, and the cylinder of the milling means being connected to the screw tube of the extruder via a connecting opening.

This device is known from AT 407 234 B. This known device has the advantage that by the direct, very short connection between the milling means and extruder on the one hand continuous feed of plastic material is ensured and on the other hand the thermal efficiency is very good since the milling energy of the milling means is delivered directly to the extrusion process.

Since in individual cases in the region of the connecting opening between the milling means and the screw tube of the extruder, material can collect which, especially for plastic material with a low melting or softening point which has been at least superficially melted or softened by the preceding milling process, settles in the connection opening and makes it increasingly smaller, the object of the invention is to make available a device of the initially named type which provides a remedy for this problem.

This object is achieved with a device with the features of claim 1.

It has been established that the wall thickness of the cylinder of the milling means or of the screw tube of the extruder in the region of the connecting opening is of decisive importance for the settling of the plastic material. On the other hand, for mechanical reasons it is not easily possible to reduce the wall thickness to the degree at which it can be reliably avoided that the material will rest permanently in the connecting opening. The asymmetrical arrangement of the connecting opening can minimize this problem since the wall thickness on the edge of the connecting opening in the region of the plane which lies in the axis of rotation of the knife shaft and at a right angle to the axis of rotation of the extruder screw can be made much smaller.

In one preferred embodiment of the invention the generating lines of the inside wall of the cylinder and of the inside wall of the screw tube touch one another in the region of the connecting opening. In one alternative embodiment the generating lines of the inside wall of the cylinder and of the inside wall of the screw tube slightly intersect one another in the region of the connecting opening, i.e. a few millimeters. In another alternative embodiment the generating lines of the inside wall of the cylinder and of the inside wall of the screw tube in the region of the connecting opening have a short distance from one another, i.e. a few millimeters.

This preferred embodiment of the invention enables the wall thickness on the edge of the connecting opening to be made additionally smaller since the cylinder of the milling means and the screw tube lie very near to one another and the connecting opening is therefore very short.

It is preferred in the invention that the edge of the connecting opening which is the rear edge viewed in the direction of rotation of the knife shaft is nearer the plane than the edge of the connecting opening opposite the rear edge. Depending on how far the inside wall of the cylinder of the milling means and of the screw tube are from one another, it can either be provided that the edge of the connecting opening which is nearer the plane viewed in the direction of rotation of the knife shaft is rounded or sharp. A sharp or rounded edge can however for a greater distance of course also be produced by the corresponding machining of the edge of the connecting opening. Deposition of material can be very effectively prevented by this sharp or rounded, but narrow edge.

Depending on the diameter or the shape of the connecting opening and its eccentricity, the angle of the tangential plane of the inside wall of the cylinder on the edge of the connecting opening can assume a certain angle to the axis of rotation of the extruder screw. Within the framework of the invention, it is preferred if the tangential plane of the inside wall of the cylinder on the edge of the connecting opening includes an angle less than or equal to 40°, preferably less than 30°, preferably less than 20° to the axis of rotation of the extruder screw. It is especially preferred here if the tangential plane of the inside wall of the cylinder on the edge of the connecting opening includes an angle between 10° and 15° to the axis of rotation of the extruder screw. When the angle of the tangential plane lies in these preferred ranges, almost automatically one edge of the connecting opening which largely prevents deposition of material is formed. The edge of the connecting opening which is farther from the plane viewed opposite the direction of rotation of the knife shaft and which is thus opposite the edge just described, encloses preferably an angle less than 90°, preferably less than 80°, to the axis of rotation of the extruder screw. This yields a shape of the connecting opening through which the plastic material is reliably supplied to a sufficient extent to the extruder so that it is always supplied with sufficient plastic material.

Other features and advantages of the device as claimed in the invention will become apparent from the following description of one preferred embodiment of the invention with reference to the attached drawings.

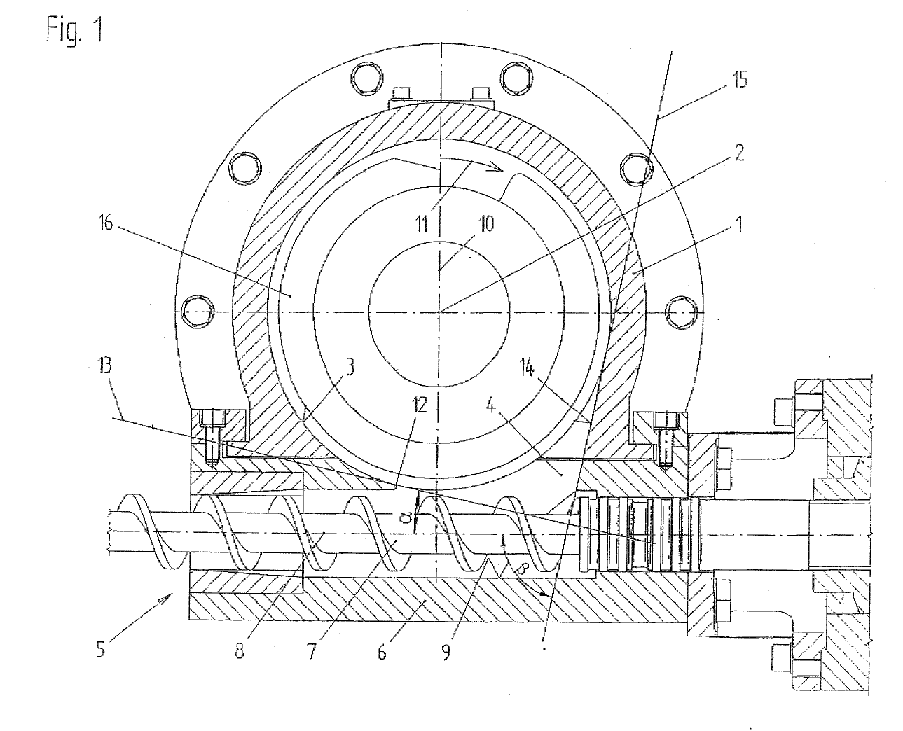

FIG. 1 shows a section through a device as claimed in the invention in the region of the connecting opening between the milling means and the extruder which lies in the axis of the extruder shaft, and

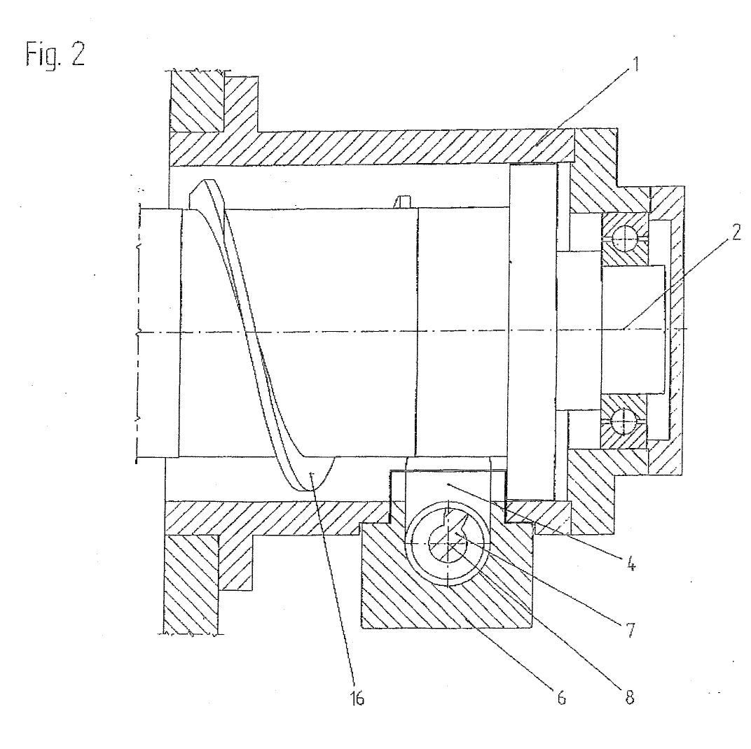

FIG. 2 shows a section in the same region in the plane of the mill shaft.

A device as claimed in the invention, as is known in itself from AT 407 234 B, has a milling means, of which in the drawings only the cylinder 1 is shown. A knife shaft which can have for example the shape known from AT 407 234 B is symbolized by its shaft axis 2. The plastic material to be milled is supplied to the cylinder 1 through a feed opening which is not shown in the drawings. The cylinder 1 has an inside wall 3 which has a connecting opening 4 which produces a connection to an extruder 5, more exactly to the screw tube 6 of the extruder 5. The extruder 5, as likewise inherently known, has an extruder screw 7 which is turned around an axis of rotation 8 and is driven by a motor.

The inside wall 3 of the cylinder 1 and the inside wall 9 of the screw tube 6 are arranged in the region of the connecting opening 4 to one another such that the shaft axis 2 and the axis of rotation 8 of the extruder screw 7 are located over one another and cross one another at a right angle, and that on the other hand the lowermost generating line of the inside wall 3 and the uppermost generating line of the inside wall 9 touch one another. In this way the knife shaft and a conveyor screw 16 which is located in its extension, which has a construction which can be made as known from AT 407 234 B and which is located over the connecting opening 4, and the extruder screw 7 which is located under the connecting opening 4 can be located very near to one another; this is important for the supply of plastic material into the extruder 5. But it is not a prerequisite for the invention that the shaft axis 2 and the axis of rotation 8 cross at a right angle, but this angle can also be different from 90°.

The connecting opening 4 with reference to the plane 10 which lies in the axis of rotation 2 of the knife shaft and at a right angle to the axis of rotation 8 of the extruder screw 7 (when the shaft axis 2 and the axis of rotation 8 do not cross at a right angle and the axis of rotation is not in the figure plane of the drawings, then this plane 10 is at a right angle to the projection of the shaft axis 8 into the figure plane) is asymmetrically arranged such that with respect to the direction of rotation 11 of the knife shaft, it is shifted against this direction of rotation 11. This results in that the edge of the connecting opening 4 which is the rear edge viewed in the direction of rotation 11 forms an edge 12 which is relatively narrow. In this embodiment, the edge 12 is rounded. The edge 12 could however also be sharp or somewhat sharp by the corresponding machining. This narrow, rounded or sharp edge 12 prevents plastic material from being deposited in the connecting opening 4 in the region of this edge 12, which material is pressed with high pressure and partially plasticized or superficially melted against this edge, dictated by the direction of rotation of the knife shaft or conveyor screw.

Depending on the geometry of the connecting opening 4, the diameter of the inside wall 3 and in the distance of the edge 12 from the plane 10, the tangential plane 13 of the inside wall 3 of the cylinder 1 on the edge of the connecting opening 4 in the region of the edge 12 assumes a certain angle α to the axis of rotation 8 of the extruder shaft 7. Within the framework of the invention it is preferred if this angle α is less than 40°, since in this way a shape of the edge 12 arises which makes it difficult for plastic material to be deposited. It is however still better if the angle α is less than 30°, preferably less than 20° and especially preferably between 10 and 15°. The smaller the angle α, the more pointed the edge 12 and the more the plastic material is prevented from settling on the edge 12. Smaller angles a would of course also be possible, but then under certain circumstances a strength problem could arise on the edge 12.

On that edge which is opposite the edge 12, the connecting opening 4 has a curved wall 14 with a tangential plane 15 which is located an at angle β to the axis of rotation 8 of the extruder screw 7. Within the framework of the invention it is preferred if this angle β is less than or equal to 90°, preferably between 70° and 80°. At this angle of the wall 14 very reliable supply of plastic material to the extruder 5 takes place.

The connecting opening 4 preferably has a somewhat elliptical shape for which the longer axis is pointed in the direction of rotation 11 of the mill shaft. The connecting opening 4 could however also have any other shape, for example a round or approximately round shape or a roughly elliptical shape at which the lengthwise axis is aligned transversely or at an angle not equal to 90° to the axis of rotation 2.

One preferred embodiment of the invention can be described in summary as follows:

A device for reworking thermoplastic material has a milling means for milling the plastic material, and an extruder 5. The milling means has a cylinder 1 with a supply opening and with a knife shaft and the extruder 5 has an extruder screw 7 in a screw tube 6. The cylinder 1 of the milling means is connected to the screw tube 6 of the extruder 5 via a connecting opening 4. In order to avoid deposition of plastic material in the connecting opening 4, the connecting opening 4 with reference to a plane 10 which lies in the axis of rotation 2 of the knife shaft and at a right angle to the axis of rotation 8 of the extruder screw 7 is arranged asymmetrically, viewed in the direction of rotation 11 of the knife shaft. In this way the wall thickness on the edge 12 of the connecting opening 4 can be made much narrower; this minimizes this problem.

1. Device for reworking of thermoplastic material with a milling means for milling the plastic material and with an extruder (5), the milling means having a cylinder (1) with a supply opening and with a knife shaft, the extruder (5) having an extruder screw (7) in a screw tube (6), and the cylinder (1) of the milling means being connected to the screw tube (6) of the extruder (5) via a connecting opening (4), characterized in that the connecting opening (4) with reference to a plane (10) which lies in the axis of rotation (2) of the knife shaft and at a right angle to the axis of rotation (8) of the extruder screw (7), is arranged asymmetrically viewed in the direction of rotation (11) of the knife shaft.

2. Device as claimed in claim 1, wherein the generating lines of the inside wall (3) of the cylinder (1) and of the inside wall (9) of the screw tube (6) touch one another in the region of the connecting opening (4).

3. Device as claimed in claim 1, wherein the generating lines of the inside wall (3) of the cylinder (1) and of the inside wall (9) of the screw tube (6) slightly intersect one another in the region of the connecting opening (4).

4. Device as claimed in claim 1, wherein the generating lines of the inside wall (3) of the cylinder (1) and of the inside wall (9) of the screw tube (6) in the region of the connecting opening (4) have a short distance from one another.

5. Device as claimed in claim 1, wherein the edge (12) of the connecting opening (4) which is the rear edge viewed in the direction of rotation (11) of the knife shaft is nearer the plane (10) than the edge of the connecting opening (4) opposite this edge (12).

6. Device as claimed in claim 1, wherein the edge (12) of the connecting opening (4) which is nearer the plane (10) viewed in the direction of rotation (11) of the knife shaft is rounded or sharp.

7. Device as claimed in claim 5, wherein the tangential plane (13) of the inside wall (3) of the cylinder (1) of the edge (12) of the connecting opening (4) includes an angle (α) less than 40°, preferably less than 30°, preferably less than 20° to the axis of rotation (8) of the extruder screw (7).

8. Device as claimed in claim 5, wherein the tangential plane (13) of the inside wall (3) of the cylinder (1) on the edge (12) of the connecting opening (4) includes an angle (α) between 10° and 15° to the axis of rotation (8) of the extruder screw (7).

9. Device as claimed in claim 1, wherein the edge of the connecting opening (4) which is farther from the plane (10) viewed opposite the direction of rotation (11) of the knife shaft forms a wall (14) which preferably includes an angle (β) less than or equal to 90°, preferably less than 80°, to the axis of rotation (8) of the extruder screw (7).

10. Device as claimed in claim 2, wherein the edge (12) of the connecting opening (4) which is the rear edge viewed in the direction of rotation (11) of the knife shaft is nearer the plane (10) than the edge of the connecting opening (4) opposite this edge (12).

11. Device as claimed in claim 2, wherein the edge (12) of the connecting opening (4) which is nearer the plane (10) viewed in the direction of rotation (11) of the knife shaft is rounded or sharp.

12. Device as claimed in claim 6, wherein the tangential plane (13) of the inside wall (3) of the cylinder (1) of the edge (12) of the connecting opening (4) includes an angle (α) less than 40°, preferably less than 30°, preferably less than 20° to the axis of rotation (8) of the extruder screw (7).

13. Device as claimed in claim 6, wherein the tangential plane (13) of the inside wall (3) of the cylinder (1) on the edge (12) of the connecting opening (4) includes an angle (α) between 10° and 15° to the axis of rotation (8) of the extruder screw (7).
